(19) United States
(12) Patent Application Publication
(10) Pub. No.: US 2006/0198612 A1
(43) Pub. Date: Sep. 7, 2006

(54) Media player and the playing method thereof

(75) Inventors: Cheng-Hao Lee, Taipei County (TW); Chang-Hung Lee, Yunlin County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/365,868

(22) Filed: Mar. 2, 2006

(30) Foreign Application Priority Data
Mar. 2, 2005 (TW) 094106198

(51) Int. Cl. H04N 7/26

(52) U.S. Cl. 386/112

(57) ABSTRACT

A media player for processing an input signal is disclosed, which comprises: a first decoder, for converting the input signal into a first decode signal using a first algorithm; a first encode, coupled to the first decoder; a storage device, coupled to the first encoder; and an image processor, for receiving and processing the first decode signal to output a play signal; wherein the first encoder uses a second algorithm to convert the first decode signal into a store signal to be saved in the storage device as the image processor stops to output the play signal.

### FIELD OF THE INVENTION

The present invention relates to an improved media player and the playing method thereof, and more particularly, to an improved media player with real-time on-line playback capability and the playing method thereof.

### BACKGROUND OF THE INVENTION

As the rapid advance of technology propelling the development of electronic related industry, electronic products had become more and more intimate to our daily life, which is especially true to televisions. Following the prevailing of cable TV, Television has established itself as the most important medium of mass communication and thus is a must-have electronic product for every family in today's diversified sociality.

Refer to FIG. 1, which is a conventional TV architecture. In FIG. 1, a transmitter 11 is disposed usually at a high land by a television company for broadcasting TV signals 10 while a television can receive the TV signals 10 by an antenna 12 thereof. As soon as a TV signal 10 is received by a television, it is processed by an image processor 13 of the television and then is displayed on a display of the television. As the standard specified by the National Television System Committee (NTSC), a NTSC video consists of 525 scan lines and 30 frames per second.

The most complained disadvantage of watching a TV program is that it is impossible to pause, forward, and backward a live TV program since TV signal is broadcasted to TV continuously. That is, a missed frame can not be retrieved for the TV to playback. It is frustrating to miss a homerun as one is momentarily distracted by a phone ring.

Attempts have been made in the prior art to overcome the problem noted above. For example, U.S. published pattern application No. 20020174445 of Miller et al., entitled “Video Playback Device With Real-Time On-Line Viewer Feedback Capability And Method Of Operation”. However, the prior-art playback device is only suitable for conventional analog television system and is not applicable to the digital television system. Moreover, since capacity of the storage device is limited, it is importance to provide a method capable of using the storage device efficiently. Therefore, it is in need of having a media player and playing method thereof that is applicable to digital television system and can use storage device efficiently.

### SUMMARY OF THE INVENTION

It is the primary object of the invention to provide a media player with real-time on-line playback capability that is applicable to a digital television system.

It is another object of the invention to provide a media player capable of using the storage device arranged therein efficiently.

To achieve the above objects, the present invention provides a media player for processing an input signal, comprising:
a first decode, for converting the input signal into a first decode signal using a first algorithm;
a first encode, coupled to the first decoder;
a storage device, coupled to the first encoder; and
an image processor, for receiving and processing the first decode signal to output a play signal;
wherein the first encoder uses a second algorithm to convert the first decode signal into a store signal to be saved in the storage device as the image processor stops to output the play signal.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a conventional architecture of television system.

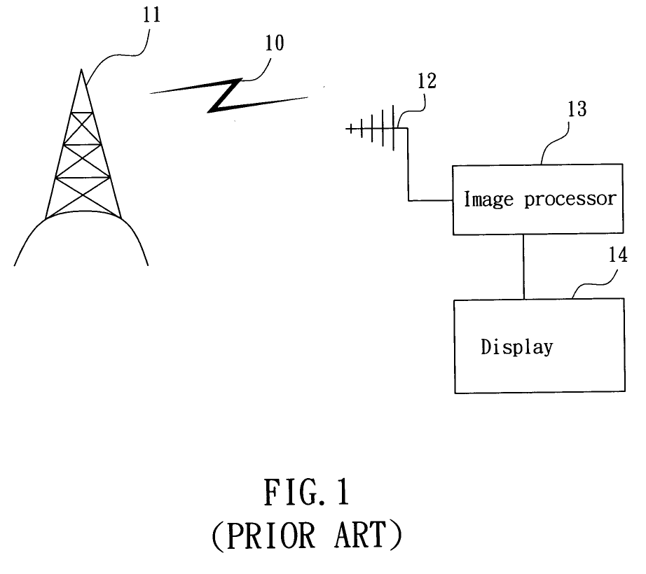

FIG. 2 is a schematic view of a media player of the present invention.

FIG. 3 is a flowchart of the playing method according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

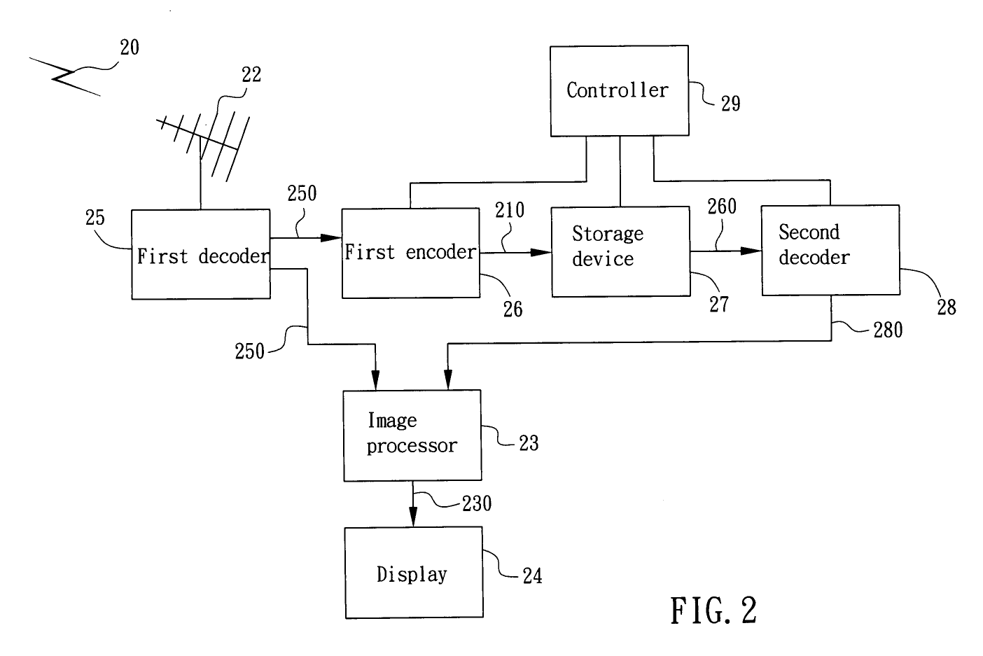

As seen in FIG. 2, the present invention provides a media player for processing an input signal 20, comprising: a first decoder 25, an image processor 23, a first encoder 26, a storage device 27 and a second decoder 28. In a preferred embodiment of the invention, the input signal 20 can be the wireless signal of a broadcast system received by an antenna or the wired signal of a cable TV company. The first decoder 25 can receive the input signal 20 and then convert the same into a first decode signal 250 using a first algorithm, moreover, the first algorithm is a method of compression/decompression while the input signal 20 is a compressed digital signal like MPEG2, or MPEG 4, and the first algorithm is a method of demodulation while the input signal 20 is a modulation signal. The first decode signal 250 is then fed to the image processor 23 where it is processed for synchronization, zoom in/out, etc., so as to generate a play signal 230 and output the same to a display 24 for displaying the play signal 230. As seen in FIG. 2, the first encoder 26 is coupled to the first decoder 25, the storage device 27 is coupled to the first encoder 26, and the second decoder 28 is coupled to the storage device 27 and the image processor 23 in respective. By virtue of this, the first encoder 26 is capable of using a second algorithm to convert the first decode signal 250 into a store signal 260 to be saved in the storage device 27 as the image processor 23 stops playing, and thereafter, as the image processor 23 is recovered from stopping, the second decoder 28 is capable of using the second algorithm to convert the store signal 260 into a second decode signal 280 and the image processor 23 receives and processing the second decode signal 280 as the play signal 230 when the image processor 23 is recovered from stopping of the output of the play signal 230. Wherein, the store signal 260 saved in the storage device 27 can be programmed and processed for enabling the same to be saved in segment, or the second decode signal 280 decoded therefrom to fast forward, slow forward and pause with respect to the preference of a user. In a preferred embodiment of the invention, the first encoder 25 continuously converts the first decode signals 250 into the store signals 210 to be saved in the storage device 27 and the image processor 23 continuously receives and processing the second decode signal 280 as the play signal 230. Or the image processor 23 is switched to receive and process the first decode signal 25 to output the play signal 230 when all of the store signal has converted by the second decoder and played by the the image processor 23.

For instance, in a wireless digital TV system, the input signal 20 of MPEG2 format received by the antenna 22 is converted into a first decode signal 250 by a first decoder 25 using an algorithm capable of decoding MPEG2, and then the first decode signal 250 is fed to an image processor 23 for further processing to be display on a display 24. As a viewer wants to leave momentarily, he makes the image processor 23 to stop displaying. Then the first encoder 26 is activated to use a second algorithm for converting the first decode signal 250 into a store signal 260 to be saved in the storage device 27, wherein the second algorithm may be a MPEG2 method or other digital compression method. As the viewer returns from the leave and reactivates the image processor 23 for displaying. The second decoder 28 uses the second algorithm to convert the saved store signal 260 into a second decode signal 280 which is then fed to the image processor 23 for displaying. From the above description, it is noted that the media player of the invention is equipped with the playback function that is applicable in the digital TV system.

Furthermore, the media player of the invention further comprises a controller 29, which is coupled to the first decoder 26, the storage device 27 and the second decoder 28, and is capable of adjusting the resolution of the second algorithm with respect to a specific status of the storage device 27. It is noted that the first algorithm is a decoding/encoding method of a first resolution and the second algorithm is a decoding/encoding method of a second resolution while the first resolution is at least equal to the second resolution and the resolution of the second algorithm is reduced as the residue capacity of the storage device is smaller than a predetermined value. For example, as the residue capacity of the storage device 27 is more than one half the overall capacity of the storage device 27, the second resolution is enable to equal to the first resolution since there are still enough storage capacity left. However, as the residue capacity of the storage device 27 is less than one half the overall capacity of the storage device 27, the second resolution is reduced by the controller 29 to a value smaller than that of the first resolution so as to increase the saving time of the storage device 27. In addition, the second resolution can be further reduced by the controller 29 as the residue capacity is lower than one fourth of the overall capacity so as to further increase the saving time of the storage device 27. Therefore, the storage device 27 is used efficiently by compromising the image quality with saving time.

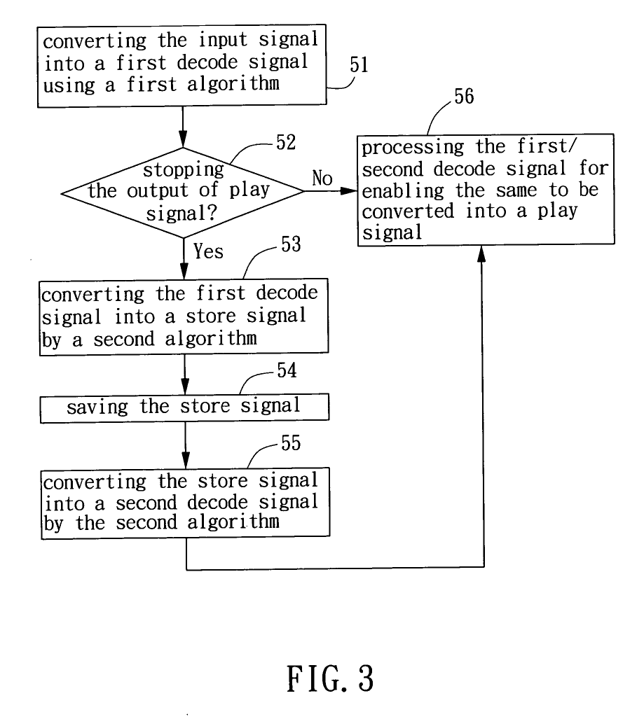

Please refer to FIG. 3, which is a flowchart of the playing method according to the present invention. The playing method of the invention is used for processing a digital input signal like a digital broadcasting signal or a digital TV signal, comprising the steps of:
step 51: converting the input signal into a first decode signal using a first algorithm;
step 52: determining whether to stop the output of a play signal? if so, the process goes to step 53; otherwise, the step goes to step 56;
step 53: converting the first decode signal into a store signal using a second algorithm;
step 54: saving the store signal;
step 55: converting the store signal into a second decode signal using the second algorithm;
step 56: processing the first/second decode signal for selectively enabling the same to be converted into a play signal.

Wherein, the first algorithm is a decoding/encoding method of a first resolution and the second algorithm is a decoding/encoding method of a second resolution while the first resolution is at least equal to the second resolution.

Moreover, in the step 53, the resolution of the second algorithm can be changed with respect to a specific status of the storage device. For example, the resolution of the second algorithm is reduced while the residue capacity of the storage device is smaller than a designated value so that the saving time of the storage device 27 can be increased.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A media player, for processing an input signal, comprising:
a first decoder, for converting the input signal into a first decode signal using a first algorithm;
a first encoder, coupled to the first decoder;
a storage device, coupled to the first encoder; and
an image processor, for receiving and processing the first decode signal to output a play signal;
wherein the first encoder uses a second algorithm to convert the first decode signal into a store signal to be saved in the storage device as the image processor stops to output the play signal.

2. The media player of claim 1, further comprising:
a second decoder, coupled to the storage device and the image processor in respective, for using the second algorithm to convert the store signal into a second decode signal, wherein the image processor receives and processing the second decode signal as the play signal when the image processor is recovered from the stop of the output of the play signal.

3. The media player of claim 2, wherein the first encoder continuously converts the first decode signals into the store signals to be saved in the storage device.

4. The media player of claim 2, wherein the image processor is switched to receive and process the first decode signal to output the play signal when the store signal has converted by the second decoder.

5. The media player of claim 1, further comprising:
a display, coupled to the image processor for displaying the play signal.

6. The media player of claim 1, wherein the first algorithm is a decoding/encoding method of a first resolution.

7. The media player of claim 6, wherein the second algorithm is a decoding/encoding method of a second resolution while the first resolution is at least equal to the second resolution.

8. The media player of claim 2, further comprising:
a controller, coupled to the first decoder, the storage device and the second decoder, capable of adjusting the resolution of the second algorithm with respect to a specific status of the storage device.

9. The media player of claim 8, wherein the resolution of the second algorithm is reduced while the residue capacity of the storage device is smaller than a predetermined value.

10. A playing method, comprising the steps of:
step A: converting an input signal into a first decode signal using a first algorithm;
step B: converting the first decode signal into a store signal using a second algorithm;
step C: saving the store signal; and
step D: processing the first decode signal for enabling the same to be converted into a play signal.

11. The playing method of claim 10, further comprising:
step C1: converting the store signal into a second decode signal using the second algorithm.

12. The playing method of claim 11, further comprising:
step D1: processing the second decode signal for enabling the same to be converted into the play signal.

13. The playing method of claim 10, further comprising:
step B1: changing the resolution of the second algorithm with respect to a specific status of the storage device.

14. The playing method of claim 13, wherein the resolution of the second algorithm is reduced while the residue capacity of the storage device is smaller than a predetermined value.

15. The playing method of claim 10, wherein the first algorithm is a decoding/encoding method of a first resolution.

16. The playing method of claim 10, the second algorithm is a decoding/encoding method of a second resolution while the first resolution is at least equal to the second resolution.
